(19) United States
(12) Patent Application Publication
(10) Pub. No.: US 2015/0320065 A1
(43) Pub. Date: Nov. 12, 2015

(54) LIQUID CREAMERS AND METHODS OF MAKING SAME

(71) Applicant: NESTEC S.A., Vevey (CH)

(72) Inventors: Jean-Baptiste Bezelgues, Beijing (CN); Yichi Xu, Dublin, OH (US); Martin Erwin Leser, Dublin, OH (US); Alexander A. Sher, Dublin, OH (US); Veneta Alahverdzhieva, Thun (CH); Jun-Tse Ray Fu, Dublin, OH (US)

(21) Appl. No.: 14/367,663

(22) PCT Filed: Dec. 19, 2012
(86) PCT No.: PCT/EP2012/076123

§ 371 Date: Jun. 20, 2014

Related U.S. Application Data
(60) Provisional application No. 61/579,362, filed on Dec. 22, 2011.

(51) Int. Cl. A23C 11/00; A23L 1/0532

(52) U.S. Cl. CPC A23C 11/00; A23L 1/0532

(57) ABSTRACT

Liquid creamers and methods of making the liquid creamers are provided. In a general embodiment, the present disclosure provides a liquid creamer comprising: between about 0.1% and 10% oil; between about 0.1% and about 35% sugar; and a hydrocolloid stabilizing system comprising kappa carrageenan and iota carrageenan having kappa carrageenan:iota carrageenan weight ratio of between about 1:2.5 and about 1:33.

### BACKGROUND

The present disclosure generally relates to food products. More specifically, the present disclosure is directed to liquid creamers for food products such as coffee and tea.

Creamers are widely used as whitening agents with hot and cold beverages such as, for example, coffee, cocoa, tea, etc. They are commonly used in place of milk and/or dairy cream. Creamers may come in a variety of different flavors and provide mouthfeel, body, and a smoother texture.

Creamers can be in liquid or powder forms. One disadvantage of powder forms is that they do not generally provide an impression of traditional dairy creamers. Another disadvantage of using powder creamers may include difficulties in dissolution when added to coffee, and also the possibility of having a non-homogeneous beverage.

Fresh or refrigerated dairy, liquid whiteners usually provide good mouthfeel but are traditionally high in fat and sugar. They may also be inconvenient to use due to short storage capabilities, as they deteriorate rapidly even under refrigeration conditions.

Current consumer trends demonstrate increased consumption of reduced-fat and reduced-sugar products, including creamers. However, fat and sugar provides provide a mouthfeel which is difficult to achieve without fat and sugar. Reducing fat and sugar content also impacts the stability of aseptic, shelf stable creamers against creaming, phase separation, de-oiling, and the like.

It is well known that emulsions and suspensions are not thermodynamically stable, and there is a real challenge to overcome physico-chemical instability issues in the liquid creamers that contain oil and other insoluble materials, especially for the aseptic liquid creamers during long storage times and at elevated temperatures. Moreover, over time, creaming that can still be invisible in the liquid beverages stored at room and elevated temperatures can cause a plug in the bottle when refrigerated.

In view of the previous discussion, there are numerous challenges in creating a dairy creamer reduced in fat and sugar with good mouthfeel, and which is shelf-stable for extended periods of time, if aseptically produced. Therefore, there is a need for stable, low-fat and/or low-sugar, liquid creamers with good mouthfeel and good physico-chemical stability.

### SUMMARY

The present disclosure relates to liquid creamers for food products and methods of making the liquid creamers. The liquid creamers can be shelf-stable and aseptic. The liquid creamers can be low-fat and/or low-sugar and have a pleasant mouthfeel. The liquid creamers can maintain good physico-chemical properties, especially emulsion and suspension stability at manageable viscosity without phase separation (e.g., creaming, sedimentation, age gelation) during different storage conditions over the full life of the liquid creamer.

In a general embodiment, the present disclosure provides a liquid creamer comprising: between about 0.1% and 10% oil; between about 0.1% and about 35% sugar; and a hydrocolloid stabilizing system comprising kappa carrageenan and iota carrageenan having kappa carrageenan:iota carrageenan weight ratio of between about 1:2.5 and about 1:33.

In any embodiments of the liquid creamer described herein, the liquid creamer can have a viscosity of between about 5 cP and about 12 cP, when measured at 20° C. and at a shear rate of 75 s⁻¹.

In any embodiments of the liquid creamer described herein, the hydrocolloid stabilizing system can comprise kappa carrageenan and iota carrageenan having a kappa carrageenan:iota carrageenan weight ratio of between about 1:2.5 and about 1:5.

In any embodiments of the liquid creamer described herein, the liquid creamer may be maintained in a homogeneous state for at least about 6 months at 4° C. and 20° C., 3 months at 30° C. and 1 months at 38° C.

In any embodiments of the liquid creamer described herein, the hydrocolloid stabilizing system can be present in an amount ranging from about 0.005% to about 1% by weight of the liquid creamer.

In any embodiments of the liquid creamer described herein, the liquid creamer can be free of cellulose, such as microcrystalline cellulose or carboxymethyl cellulose.

In any embodiments of the liquid creamer described herein, the oil can comprise from about 10% to 100% by weight of milk fat.

In any embodiments of the liquid creamer described herein, the liquid creamer can further comprise milk protein.

In any embodiments of the liquid creamer described herein, the liquid creamer can further comprise skim milk solids.

In any embodiments of the liquid creamer described herein, the liquid creamer can further comprise a flavor ingredient.

In another embodiment, the present disclosure provides a method of making a stable liquid creamer, the method comprising mixing: between about 0.1% and 10% oil, between about 0.1% and about 35% sugar, and a hydrocolloid stabilizing system comprising kappa carrageenan and iota carrageenan having a kappa carrageenan:iota carrageenan weight ratio of between about 1:2.5 and about 1:33; and filling a container with the liquid creamer.

In an embodiment, the method comprises heat treating the liquid creamer before filling the container.

In any embodiment of the method, the liquid creamer may have a viscosity of between about 5 cP and about 12 cP, when measured at 20° C. and at a shear rate of 75 s⁻¹.

In any embodiment of the method, preferably no cellulose, such as microcrystalline cellulose or carboxymethyl cellulose, is added to the liquid creamer

An advantage of the present disclosure is to provide an improved low-fat and/or low-sugar, liquid creamer.

Another advantage of the present disclosure is to provide a low-fat, liquid creamer having a pleasant mouthfeel.

Yet another advantage of the present disclosure is to provide a liquid creamer that does not have stability issues such as de-oiling, flocculation, and/or sedimentation during storage.

Additional features and advantages are described herein, and will be apparent from, the following Detailed Description and the figures.

### BRIEF DESCRIPTION OF THE DRAWINGS

FIG. 1 shows the slope (ΔT/Δt) of the curve of the integral transmission (T) plotted as a function of time (t) as measured by Lumisizer in examples 1-5. A higher slope indicate a faster separation and thus a less stable product.

FIG. 2 shows the viscosity as a function of temperature measured at a shear rate of 75 s⁻¹ for the samples of examples 1-5.

### DETAILED DESCRIPTION

The present disclosure relates to liquid creamers and methods of making the liquid creamers. The liquid creamer can be added to any suitable beverage in an amount sufficient to provide a creaming effect to the beverage. A creaming effect imparts qualities associated with cream or dairy such as desirable, flavor, texture, body, and/or color (e.g., lightening or whitening). In alternative embodiments, the liquid creamers are stable and overcome phase separation issues (e.g., creaming, plugging, gelation, syneresis, sedimentation, etc.) during storage at refrigeration temperatures (e.g., ˜4° C.), room temperatures (e.g., ˜20° C.) and elevated temperatures (e.g., ˜30 to 38° C.). The stable liquid creamers can have a shelf-life stability, for example, for at least 6 months at 20° C., 6 months at 30° C., and 1 month at 38° C.

The low-fat, liquid creamers in embodiments of the present disclosure can be formed by the interaction of oil, sugar, and optionally, milk protein and flavor(s), and stabilized by the use of a hydrocolloid stabilizing system comprising kappa carrageenan and iota carrageenan. It has been surprisingly found that a specific combination of kappa carrageenan and iota carrageenan significantly improved the mouthfeel and the physico-chemical stability of low-fat and/or low-sugar, liquid creamers. For example, the specific combinations of these components provide stable, low-fat and/or low-sugar, liquid creamers without phase separation during different storage conditions over an extended period of time. In addition, the unique combination of kappa carrageenan and iota carrageenan was advantageously and unexpectedly found to provide the creamers with a good mouthfeel and viscosity.

As used herein, the term “stable” means remaining in a state or condition having minimal phase separation (e.g., creaming, sedimentation, age gelation) for an extended period of time (e.g., for at least 1 month). Stable liquid creamers according to embodiments of the present disclosure can be found to be stable when maintained for at least 1 month, and are generally stable from 6 months at 4 or 20° C. or longer without feathering, flocculation, sedimentation issues.

In a general embodiment, the present disclosure provides a liquid creamer including 1) oil, 2) sugar, and 3) a hydrocolloid stabilizing system comprising kappa carrageenan and iota carrageenan having a kappa carrageenan:iota carrageenan weight ratio of between about 1:2.5 and about 1:33. In one embodiment the hydrocolloid stabilizing system comprising kappa carrageenan and iota carrageenan having a kappa carrageenan:iota carrageenan weight ratio of between about 1:2.5 and about 1:5. In an embodiment the hydrocolloid stabilizing system is present in an amount ranging from about 0.005% to about 1% by weight of the liquid creamer, such as e.g. between about 0.02% and about 0.5%.

The hydrocolloid stabilizing system can stabilize the creamer and provide a pleasant mouthfeel and viscosity. In an embodiment the In one embodiment, the liquid creamer has a viscosity of between about 5 cP and about 12 cP, when measured at 20° C. and at a shear rate of 75 s⁻¹. In an embodiment the liquid creamer does not comprise cellulose, such as microcrystalline cellulose or carboxymethyl cellulose

The oil content of the liquid creamer can range from about 0.1% to about 10% by weight of the liquid creamer. In an embodiment, the oil content ranges between about 1% and about 7% by weight of the liquid creamer. In another embodiment, the liquid creamer is maintained in a homogeneous state for at least about 6 months at 20° C., 6 months at 4° C., 3 months at 30° C. and 1 month at 38° C.

The oil may be any suitable oil or fat. The oil may be emulsified in any suitable way, in one embodiment the oil is emulsified in milk solids. In an embodiment the oil comprises, or consist of, milk fat. The oil may e.g. comprise between about 10% and 100% of milk fat Milk fat may be provided in any suitable way, e.g. as cream, butter, and/or butter-oil. If milk fat is provided in the form of cream, not further emulsifiers may be needed.

In an embodiment, the liquid creamer comprises milk protein. Milk protein may be e.g. be in the form of skim milk, whole milk, cream, buttermilk, caseinate, whey proteins, milk powder, and/or cream powder. In an embodiment, the liquid creamer comprises skim milk solids. By skim milk solids is understood a composition of the solid components of skim milk, including whey protein, casein, lactose, calcium and minor amounts of milk fat. Skim milk solids may e.g. be provided in the form of skim milk, skim milk powder, whole milk, cream, whole milk powder, and/or cream powder.

The liquid creamer of the invention comprises between 0.1% and 35% sugar. Sugar may be provided in the form of sucrose, glucose, fructose or like. In an embodiment sugar comprises between 1% and 10% by weight of the liquid creamer.

In an embodiment the liquid creamer of the invention is a dairy creamer. By a dairy creamer is understood a creamer wherein the oil is milk fat, and wherein substantially no non-milk protein is present. In one embodiment, the liquid creamer comprises cream and skim milk.

In an embodiment, skim milk ranges from about 50% to about 90% by weight of the liquid creamer. In another embodiment, cream ranges from about 5% to about 10% by weight of the liquid creamer.

In an embodiment, the liquid creamer further includes one or more additional ingredients such as flavors, sweeteners or a combination thereof. For example, for improved flavor acceptance, the liquid creamers can contain sweeteners including, but not limited to, natural sweeteners and/or artificial sweeteners or a combination thereof. More specifically, the sweeteners can include, for example, dextrose, maltose, dextrin, levulose, tagatose, galactose, and other natural or artificial sweeteners. Sugarless sweeteners can include, but are not limited to, sugar alcohols such maltitol, xylitol, sorbitol, erythritol, mannitol, isomalt, lactitol, hydrogenated starch hydrolysates, and the like, alone or in combination. Further, the liquid creamers can contain one or more flavors such as French vanilla, caramel, hazelnut, strawberry and/or other fruity flavors, alone or in combination.

Usage level of the flavors and sweeteners will vary greatly and will depend on such factors as potency of the sweetener, desired sweetness of the product, level and type of flavor used and cost considerations.

The stable, liquid creamers in embodiments of the present disclosure can be easily dispersible in coffee, stable in hot and cold acidic environments without feathering, breaking emulsion, de-oiling, flocculation and sedimentation. When added to coffee, tea, cocoa or other liquid products, the liquid creamers can provide a good mouthfeel, full body, smooth texture. The liquid creamers can be used with other various food products such as cereals, as cream for berries, creamers for soups and in many cooking applications.

In an embodiment, the present disclosure provides a method of making a stable liquid creamer. The method comprises mixing between about 0.1% and 10% oil, between about 0.1% and about 35% sugar, and a hydrocolloid stabilizing system comprising kappa carrageenan and iota carrageenan having a kappa carrageenan:iota carrageenan weight ratio of between about 1:2.5 and about 1:33; and filling a container with the liquid creamer.

If liquid ingredients, such as e.g. cream and skim milk is used, ingredients may be mixed without the addition of water, alternatively water may be added. The mixing can be done e.g., at 4° C. to 90° C. under agitation, and may be followed by heat treatment (e.g., sterilizing the mixture using a conventional ultra-high temperature (“UHT”) treatment). The liquid creamer may be cooled before filling into containers. Filling in containers may be performed under aseptic conditions. Aseptic heat treatment may use direct or indirect UHT processes. UHT processes are known in the art. Examples of UHT processes include UHT sterilization and UHT pasteurization.

Direct heat treatment can be performed by injecting steam water in the product. In this case, it may be necessary to remove excess water, for example, by flashing. Indirect heat treatment can be performed with a heat transfer interface in contact with the product. Homogenization may be performed before and/or after heat treatment. It may be interesting to perform homogenization before heat treatment in order to improve heat transfers in the emulsion, and thus achieve an improved heat treatment. Performing a homogenization after heat treatment usually ensures that the oil droplets in the emulsion have the desired dimension. Aseptic filling is described in various publications, such as articles by L, Grimm in “Beverage Aseptic Cold Filling” (Fruit Processing, July 1998, p. 262-265), by R. Nicolas in “Aseptic Filling of UHT Dairy Products in HDPE Bottles” (Food Tech. Europe, March/April 1995, p. 52-58) or in U.S. Pat. No. 6,536,188 to Taggart, which are incorporated herein by reference.

In an embodiment, the method comprises heat treating the liquid creamer before filling the container. In one embodiment, the liquid creamer has a viscosity of between about 5 cP and about 12 cP, when measured at 20° C. and at a shear rate of 75 s⁻¹. In a further embodiment, no cellulose, such as microcrystalline cellulose or carboxymethyl cellulose, is added to the liquid creamer

The aseptic liquid creamer, when added to a beverage, produces a physically stable, homogeneous, whitened drink with a good mouthfeel, body, and smooth texture. The use of the liquid creamers is not limited for only coffee applications. For example, the creamers can be also used for other beverages, such as tea or cocoa, or used with cereals or berries, creamers for soups, and in many cooking applications, etc.

To summarize, the liquid creamers in embodiments can overcome phase separation issues (e.g., creaming, plugging, gelation, syneresis, sedimentation, etc.) during storage at refrigeration (˜4° C.), room (e.g., 20 and 25° C.) and elevated temperatures (e.g., 30 and 38° C.). The liquid creamers can have a shelf-life stability for at least 6 months at 4° C. and 20° C., 3 months at 30° C. and 1 month at 38° C. The liquid creamers can provide a pleasant mouthfeel and viscosity. When added to hot, high acidic, high calcium/magnesium containing beverages, the liquid creamers do not have physico-chemical instability issues such as de-oiling, flocculation, feathering and/or sedimentation, but provide a good mouthfeel, body, smooth texture, and a good viscosity, itself and when added to a beverage such as, for example, coffee or tea.

### EXAMPLES

By way of example and not limitation, the following examples are illustrative of various embodiments of the present disclosure.

Viscosity was measured with an Anton Paar Physica MCR 501 rheometer, using double-gap geometry. All samples were evaluated using the following procedure: Viscosity was obtained at temperatures ranging from 4° to 40° C. at the shear rate of 75 s⁻¹ and the heating rate of 1° C./min.

Emulsion stability was evaluated using a Lumisizer, LS 611. The Lumisizer works on the principle of centrifugation of samples (at different g force, for a given time). Transmission profiles were generated, and Space and Time resolved extinction coefficients of the samples were recorded. Transmission profiles of samples were recorded every 40 sec for total duration time of 10160 sec at the applied centrifugation force of 2325 g. Separation graphs showed movements of the interface between the dispersed phase, e.g. the movement of emulsion layers, and the clear phase, as a function of time. The difference in the separation rates between the samples allowed assessing relative stability of the products. The integral transmission (T) was plotted as a function of time (t), and the slope (ΔT/Δt) was calculated. A higher slope indicated a faster separation and thus a less stable product.

A dry blend of carrageenan with sucrose was prepared by mixing together sucrose with kappa- and of iota-carrageenan at the carraggenan to sucrose ratio of 1:5. The dry blend was added into skim milk (˜4-6° C.) under high agitation. Then, pasteurized cream was added to the mixing tank under continuous agitation. Powder flavors were added to the tank under agitation.

The liquid was pre-heated, UHT treated for 5 sec at 143° C., homogenized at 140/35 bar, cooled and the liquid creamer was aseptically filled into bottles.

The liquid creamer was stored 1 month at 38° C., 3 months at 30° C. and 6 months at 4° C. and room temperature (20° C.).

Physico-chemical stability and sensory of creamer and coffee beverage with added liquid creamer was judged by non-trained panelists.

### Example 1

A liquid creamer was prepared as described above and stability and viscosity was tested. The composition was as follows:

| | |
|---|---|
| Sugar | 20.000 |
| skim milk | 69.500 |
| pasteurized cream | 10.000 |
| Kappa-crrageenan | 0.000 |
| Iota-carrageenan | 0.000 |
| Flavor | 0.500 |
| total (%) | 100.000 |

### Example 2

A liquid creamer was prepared as described above and stability and viscosity was tested. The composition was as follows:

| | |
|---|---|
| Sugar | 20.000 |
| skim milk | 69.455 |
| pasteurized cream | 10.000 |
| Kappa-crrageenan | 0.015 |
| Iota-carrageenan | 0.030 |
| Flavor | 0.500 |
| total (%) | 100.000 |

### Example 3

A liquid creamer was prepared as described above and stability and viscosity was tested. The composition was as follows:

| | |
|---|---|
| Sugar | 20.000 |
| skim milk | 69.453 |
| pasteurized cream | 10.000 |
| Kappa-crrageenan | 0.012 |
| Iota-carrageenan | 0.035 |
| Flavor | 0.500 |
| total (%) | 100.000 |

### Example 4

A liquid creamer was prepared as described above and stability and viscosity was tested. The composition was as follows:

| | |
|---|---|
| Sugar | 20.000 |
| skim milk | 69.460 |
| pasteurized cream | 10.000 |
| Kappa-crrageenan | 0.010 |
| Iota-carrageenan | 0.030 |
| Flavor | 0.500 |
| total (%) | 100.000 |

### Example 5

A liquid creamer was prepared as described above and stability and viscosity was tested. The composition was as follows:

| | |
|---|---|
| Sugar | 25.000 |
| skim milk | 44.500 |
| pasteurized cream | 30.000 |
| Kappa-crrageenan | 0.000 |
| Iota-carrageenan | 0.000 |
| Flavor | 0.500 |
| total (%) | 100.000 |

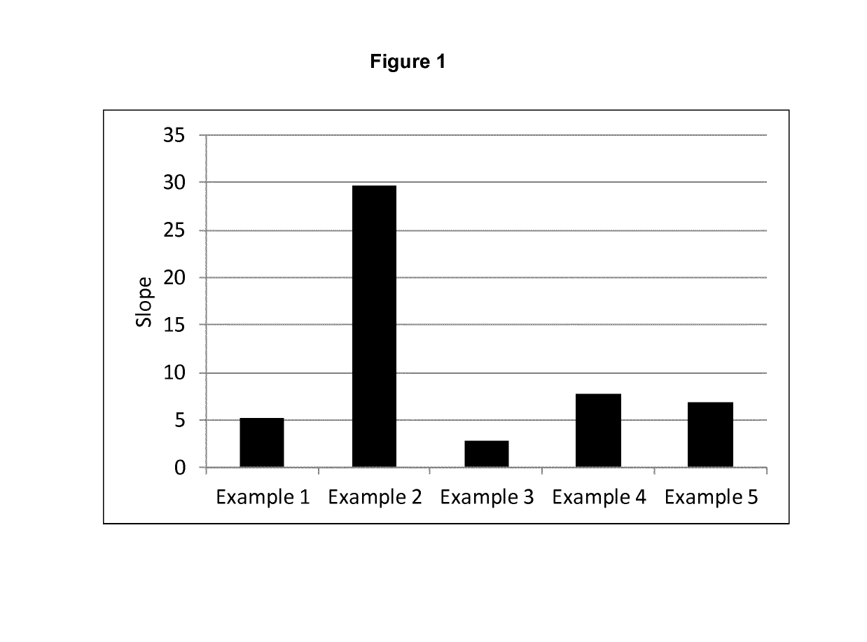

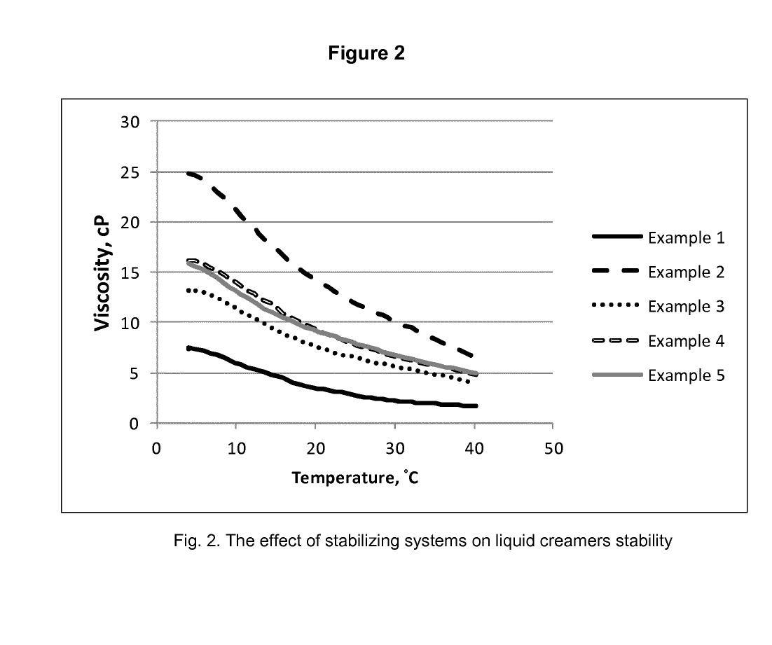

Results of viscosity and stability measurements for all examples are shown in FIGS. 1 and 2.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A liquid creamer comprising:
about 0.1% and 10% oil;
about 0.1% and about 35% sugar; and
a hydrocolloid stabilizing system comprising kappa carrageenan and iota carrageenan having a kappa carrageenan:iota carrageenan weight ratio of about 1:2.5 and about 1:33.

2. The liquid creamer of claim 1, wherein the liquid creamer has a viscosity of about 5 cP and about 12 cP, when measured at 20° C. and at a shear rate of 75 s⁻¹.

3. The liquid creamer of claim 1, wherein the liquid creamer is maintained in a homogeneous state for at least about 6 months at 4° C. and 20° C., 3 months at 30° C. and 1 months at 38° C.

4. The liquid creamer of claim 1, wherein the oil comprises about 1% and about 7% by weight of the liquid creamer.

5. The liquid creamer of claim 1, wherein the liquid creamer comprises about 1% and about 10% by weight of sugar.

6. The liquid creamer of claim 1, wherein the hydrocolloid stabilizing system comprises kappa carrageenan and iota carrageenan having a kappa carrageenan:iota carrageenan weight ratio of about 1:2.5 and about 1:5.

7. The liquid creamer of claim 1, wherein the hydrocolloid stabilizing system comprises about 0.005% to about 1% by weight of the liquid creamer.

8. The liquid creamer of claim 1, wherein the liquid creamer does not include cellulose.

9. The liquid creamer of claim 1, wherein the oil comprises milk fat.

10. The liquid creamer of claim 9, wherein the oil comprises from about 10% to 100% by weight of milk fat.

11. The liquid creamer of claim 1, wherein the liquid creamer comprises milk protein.

12. A method of making a stable liquid creamer comprising mixing:
about 0.1% and 10% oil;
about 0.1% and about 35% sugar; and
a hydrocolloid stabilizing system comprising kappa carrageenan and iota carrageenan having a kappa carrageenan:iota carrageenan weight ratio of about 1:2.5 and about 1:33; and
filling a container with the liquid creamer.

13. The method of claim 12 comprising heat treating the liquid creamer before filling the container.

14. The method of claim 12, wherein the liquid creamer has a viscosity of about 5 cP and about 12 cP, when measured at 20° C. and at a shear rate of 75 s⁻¹.

15. The method of claim 12, wherein no cellulose is added to the liquid creamer.
